(19) United States
(12) Patent Application Publication
(10) Pub. No.: US 2023/0179927 A1
(43) Pub. Date: Jun. 8, 2023

(54) Silicon-Based Microphone Apparatus And Electronic Device

(71) Applicant: GMEMS Tech Shenzhen Limited, shenzhen Guangdong (CN)

(72) Inventors: Yunlong Wang, Shenzhen Guangdong (CN); Guanghua Wu, Shenzhen Guangdong (CN); Xingshuo Lan, Shenzhen Guangdong (CN)

(73) Assignee: GMEMS Tech Shenzhen Limited, Shenzhen Guangdong (CN)

(21) Appl. No.: 17/923,107

(22) PCT Filed: Feb. 7, 2021
(86) PCT No.: PCT/CN2021/075883

§ 371 Date: Nov. 3, 2022

(30) Foreign Application Priority Data
Jun. 9, 2020 (CN) 202010520020.7

(51) Int. Cl. H04R 19/04; H04R 1/04; H04R 3/00; H04R 19/00; H04R 7/04

(52) U.S. Cl. CPC H04R 19/04; H04R 1/04; H04R 3/005; H04R 19/005; H04R 7/04; H04R 2410/03

(57) ABSTRACT

Provided are a silicon-based microphone device and an electronic apparatus. The silicon-based microphone device comprises: a circuit board, wherein at least two sound inlets are formed on the circuit board; a shielding housing that covers one side of the circuit board; an even number of differential silicon-based microphone chips that all are located in a sound cavity, wherein in each two differential silicon-based microphone chips, the first microphone structure of one differential silicon-based microphone chip is electrically connected to the second microphone structure of the other differential silicon-based microphone chip, and the second microphone structure of said one differential silicon-based microphone chip is electrically connected to the first microphone structure of said other differential silicon-based microphone chip; and a mounting plate, wherein an even number of holes communicated with the sound inlets are formed on the mounting plate.

### TECHNICAL FIELD

The present disclosure relates to a technical field of acoustic-electrical conversion, and in particular, the present disclosure relates to a silicon-based microphone device and an electronic apparatus.

### BACKGROUND

With the development of wireless communication, users of terminals such as mobile phones are increasing. As for requirements on a mobile phone, users are not merely satisfied with telephone conversation, and further require a high-quality conversation effect. Especially with the development of mobile multimedia technology, the conversation quality of the mobile phone becomes more important. A microphone of the mobile phone functions as a voice pickup device of the mobile phone, and the design thereof directly affects the quality of the call. Currently, the most widely used microphones include traditional electret microphones and silicon-based microphones.

When an existing silicon-based microphone obtains a sound signal, a silicon-based microphone chip in the microphone generates a vibration due to a sound wave obtained therefrom, and the vibration brings about variation in capacitance that may form an electrical signal, thereby converting the sound wave into an electrical signal to be output. However, the existing microphone is unsatisfactory in processing of the noise, and thus quality of audio signal output is affected.

### SUMMARY

With respect to defects in the existing methods, the present disclosure proposes a silicon-based microphone device and an electronic apparatus, which are used to solve the technical problem existing in the prior art that the noise processing of the microphone is not ideal and thus the quality of the output audio signal is affected.

According to a first aspect, embodiments of the present disclosure provide a silicon-based microphone device, including: a circuit board provided with at least two sound inlet holes; a shielding housing covering one side of the circuit board and forming a sound cavity with the circuit board; an even number of differential silicon-based microphone chips, all of which are located inside the sound cavity, wherein the differential silicon-based microphone chips are respectively disposed at the sound inlet holes, and a back cavity of each of the differential silicon-based microphone chips is communicated with a corresponding one of the sound inlet holes; in every two of the differential silicon-based microphone chips, a first microphone structure of one of the differential silicon-based microphone chips is electrically connected with a second microphone structure of another one of the differential silicon-based microphone chips, and a second microphone structure of the one of the differential silicon-based microphone chips is electrically connected with a first microphone structure of the another one of the differential silicon-based microphone chips; and a mounting plate disposed on a side of the circuit board away from the shielding housing, wherein the mounting plate is provided with an even number of openings, the openings are communicated with the sound inlet holes respectively, at least one of the openings is used for obtaining a sound wave in a first region, and at least another one of the openings is used for obtaining a sound wave in a second region.

According to a second aspect, embodiments of the present disclosure provide an electronic apparatus including the silicon-based microphone device described in the first aspect.

The beneficial technical effects brought about by the technical solutions provided in the embodiments of the present disclosure are as follows. An even number of differential silicon-based microphone chips are used for acoustic-electrical conversion. In every two of the differential silicon-based microphone chips, the back cavity of one of the differential silicon-based microphone chips obtains the sound wave in the first region through the sound inlet hole on the circuit board and the opening of the mounting plate. Thus, the sound wave in the first region may act on the differential silicon-based microphone chip, and a first sound wave electrical signal is generated by the differential silicon-based microphone chip.

The back cavity of another one of the differential silicon-based microphone chips obtains the sound wave in the second region through the sound inlet hole on the circuit board and the opening on the mounting plate. Thus, the sound wave in the second region may act on the differential silicon-based microphone chip, and a second sound wave electrical signal is generated by the differential silicon-based microphone chip.

Under the action of the sound waves, the first microphone structure and the second microphone structure in the differential silicon-based microphone chip may generate electrical signals having the same amplitude and the opposite sign. Therefore, in embodiments of the present disclosure, in every two of the differential silicon-based microphone chips, the first microphone structure of one of the differential silicon-based microphone chips is electrically connected with the second microphone structure of another one of the differential silicon-based microphone chips, and the second microphone structure of the one of the differential silicon-based microphone chips is electrically connected with the first microphone structure of the another one of the differential silicon-based microphone chips. Thus, the first sound wave electrical signal generated by the one of the differential silicon-based microphone chips may be superimposed with the first sound wave electrical signal generated by the another one of the differential silicon-based microphone chips, such that the homologous sound wave signals (usually being noise signals) having the same amplitude and the opposite sign in variation in the first sound wave electrical signal and the second sound wave electrical signal can be attenuated or cancelled, thereby improving the quality of the audio signal.

Additional aspects and advantages of the present disclosure will be given in part in the following description, which will become apparent from the following description, or be learned by practice of the present disclosure.

### BRIEF DESCRIPTION OF DRAWINGS

The above and/or additional aspects and advantages of the present disclosure will become apparent and readily understood from the following description of embodiments, taken in conjunction with the accompanying drawings, in which:

FIG. 1 is a schematic diagram of an internal structure of a silicon-based microphone device according to an embodiment of the present disclosure;

FIG. 2 is a schematic diagram of the structure of a mounting plate and a connecting ring in a silicon-based microphone device according to an embodiment of the present disclosure;

FIG. 3 is a schematic diagram of the structure of a single differential silicon-based microphone chip in a silicon-based microphone device according to an embodiment of the present disclosure; and

FIG. 4 is a schematic diagram of the connection of two differential silicon-based microphone chips in a silicon-based microphone device according to an embodiment of the present disclosure.

### EXPLANATION OF REFERENCE NUMERALS IN DRAWINGS

100: circuit board; 110a: first sound inlet hole; 110b: second sound inlet hole;
200: shielding housing; 210: sound cavity;
300: differential silicon-based microphone chip; 300a: first differential silicon-based microphone chip; 300b: second differential silicon-based microphone chip;
301: first microphone structure; 301a: first microphone structure of the first differential silicon-based microphone chip; 301b: first microphone structure of the second differential silicon-based microphone chip;
302: second microphone structure; 302a: second microphone structure of the first differential silicon-based microphone chip; 302b: second microphone structure of the second differential silicon-based microphone chip;
303: back cavity; 303a: back cavity of the first differential silicon-based microphone chip; 303b: back cavity of the second differential silicon-based microphone chip;
310: upper back plate; 310a: first upper back plate; 310b: second upper back plate;
311: upper airflow hole;
312: upper back plate electrode; 312a: upper back plate electrode of the first upper back plate; 312b: upper back plate electrode of the second upper back plate;
313: upper air gap;
320: lower back plate; 320a: first lower back plate; 320b: second lower back plate;
321: lower airflow hole;
322: lower back plate electrode; 322a: lower back plate electrode of the first lower back plate; 322b: lower back plate electrode of the second lower back plate;
323: lower air gap;
330: semiconductor diaphragm; 330a: first semiconductor diaphragm; 330b: second semiconductor diaphragm;
331: semiconductor diaphragm electrode; 331a: semiconductor diaphragm electrode of the first semiconductor diaphragm; 331b: semiconductor diaphragm electrode of the second semiconductor diaphragm;
340: silicon substrate; 340a: first silicon substrate; 340b: second silicon substrate;
341: via hole;
350: first insulating layer;
360: second insulating layer;
370: third insulating layer;
380: wire;
400: control chip;
500: mounting plate; 510: first opening; 520: second opening;
610: first connecting ring; 620: second connecting ring;
710: first sound inlet channel structure; 720: second sound inlet channel structure.

### DETAILED DESCRIPTION OF EMBODIMENTS

The present disclosure is described in detail below, and examples of embodiments of the present disclosure are illustrated in the accompanying drawings, in which the same or similar reference numerals throughout refer to the same or similar components, or components having the same or similar functions. Also, detailed descriptions of known technologies are omitted if they are not necessary for illustrating features of the present disclosure. The embodiments described below with reference to the accompanying drawings are exemplary and are only used to explain the present disclosure, but not to be construed as a limitation on the present disclosure.

It is to be understood by those skilled in the art that all terms (including technical and scientific terms) used herein have the same meaning as commonly understood by one of ordinary skill in the art to which the present disclosure belongs unless otherwise defined. It is to be further understood that terms, such as those defined in a general dictionary, should be understood to have meanings consistent with meanings thereof in the context of the prior art, and unless specifically defined as herein, should not be interpreted in idealistic or overly formal meaning to explain.

It is to be understood by those skilled in the art that the singular forms “a”, “an”, “the” and “this” used herein may also include the plural forms unless expressly stated. It is to be further understood that the word “comprise” or “include” used in the specification of the present disclosure refers to presence of the stated feature, integer, element and/or component, but does not exclude presence or addition of one or more other features, integers, elements, components and/or combination thereof. It is to be understood that when an element is referred to as being “connected” or “coupled” to another element, it may be directly connected or coupled to the other element or intervening elements may also be present. Furthermore, “connected” or “coupled” as used herein may include wirelessly connection or wirelessly coupling. As used herein, the term “and/or” includes all combination of all or any unit of the one or more associated listed items.

The inventor of the present disclosure has conducted researches and found that, with the popularization of IOT (The Internet of Things) devices such as smart speakers, it is not an easy thing for users to use a voice command on a smart device that is issuing a sound, for example, to issue a voice command such as an interrupt command or an wake-up command, etc. to a smart speaker that is playing music, or to communicate by using a hands-free operation of a mobile phone. Users often need to interrupt the playing music with a special wake-up word when getting as close to the IOT device as possible, and then perform human-computer interaction. In these typical voice interaction scenarios, since the IOT device is in use, a noise inside the housing thereof is formed due to the IOT device being playing music or making sound through a speaker, and such noise is picked up by a microphone in the IOT device, such that an effect of echo cancellation is not excellent. This phenomenon is particularly significant in smart home products which may generate a louder internal noise, such as a mobile phone playing music, TWS (True Wireless Stereo) headphone, a robot vacuum, a smart air conditioner, and smart kitchen ventilator.

The silicon-based microphone device and electronic apparatus provided by the present disclosure are intended to solve the above technical problems in the prior art.

The technical solutions of the present disclosure and how to solve the above-mentioned technical problems by using the same are described in detail below with reference to detailed embodiments.

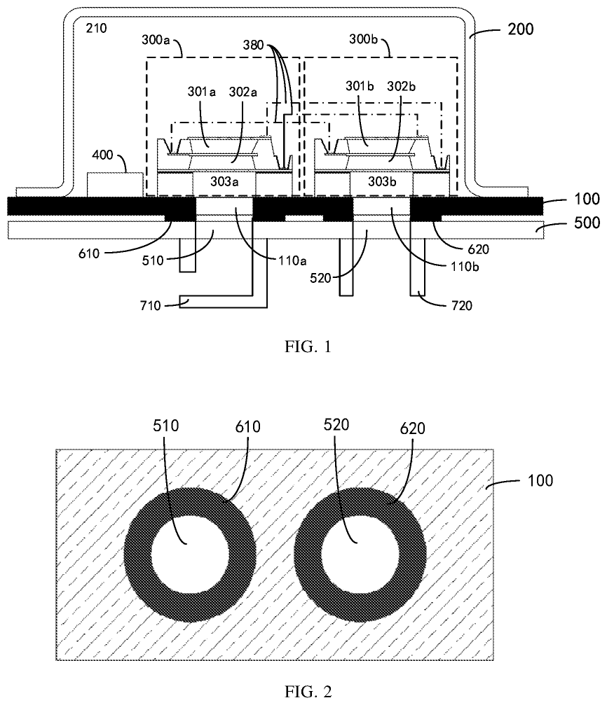

An embodiment of the present disclosure provides a silicon-based microphone device, and the schematic diagram of the structure of the silicon-based microphone device is shown in FIG. 1 and FIG. 2. The silicon-based microphone device includes a circuit board 100, a shielding housing 200, an even number of differential silicon-based microphone chips 300 and a mounting plate 500.

The circuit board 100 may be provided with at least two sound inlet holes therein.

The shielding housing 200 covers one side of the circuit board 100 and forms a sound cavity 210 with the circuit board 100.

An even number of differential silicon-based microphone chips 300 are all located inside the sound cavity 210. The differential silicon-based microphone chips 300 are respectively disposed at the sound inlet holes in a one-to-one correspondence, and a back cavity 303 of each of the differential silicon-based microphone chips 300 is communicated with a corresponding one of the sound inlet holes. In every two of the differential silicon-based microphone chips 300, a first microphone structure 301 of one of the differential silicon-based microphone chips 300 is electrically connected with a second microphone structure 302 of the other one of the differential silicon-based microphone chips 300, and the second microphone structure 302 of the one of the differential silicon-based microphone chips 300 is electrically connected with the first microphone structure 301 of the other one of the differential silicon-based microphone chips 300.

The mounting plate 500 is disposed on a side of the circuit board 100 away from the shielding housing 200. The mounting plate 500 is provided with an even number of openings therein, and the openings are communicated with the sound inlet holes. At least one of the openings is used for obtaining a sound wave in a first region, and at least another one of the openings is used for obtaining a sound wave in a second region.

In the embodiment, an even number of differential silicon-based microphone chips 300 are used to perform an acoustic-electrical conversion. It is to be noted that the silicon-based microphone device in FIG. 1 is only illustrated as including two differential silicon-based microphone chips 300, but the number of the differential silicon-based microphone chips 300 is not limited thereto.

In some possible embodiments, in every two openings, one opening is used for obtaining the sound wave in the first region, and the other opening is used for obtaining the sound wave in the second region. That is, in every two differential silicon-based microphone chips 300, the back cavity 303 of one differential silicon-based microphone chip 300 obtains the sound wave in the first region through a sound inlet hole on the circuit board 100 and an opening on the mounting plate 500, the back cavity 303 of the other differential silicon-based microphone chip 300 obtains the sound wave in the second region through the other sound inlet hole on the circuit board 100 and the other opening on the mounting board 500.

Specifically, a back cavity 303a of a first differential silicon-based microphone chip 300a is communicated with the first region through a first sound inlet hole 110a in the circuit board 100 and a first opening 510 in the mounting plate 500, so that the sound wave in the first region may act on the first differential silicon-based microphone chip 300a, and the first differential silicon-based microphone chip 300a generates a first sound wave electrical signal.

A back cavity 303b of a second differential silicon-based microphone chip 300b is communicated with the second region through a second sound inlet hole 110b in the circuit board 100 and a second opening 520 in the mounting plate 500, so that the sound wave in the second region can be applied to the second differential silicon-based microphone chip 300a, and the second differential silicon-based microphone chip 300b generates a second sound wave electrical signal.

For convenience of description, a microphone structure in the differential silicon-based microphone chip 300 away from the circuit board 100 is defined as the first microphone structure 301, and a microphone structure in the differential silicon-based microphone chip 300 close to the circuit board 100 is defined as the second microphone structure 302.

Under action of the sound waves, the first microphone structure 301 and the second microphone structure 302 in the differential silicon-based microphone chip 300 may respectively generate electrical signals having the same amplitude and the opposite sign in variation. Thus, in the embodiment of the present disclosure, the first microphone structure 301a of the first differential silicon-based microphone chip 300a is electrically connected with the second microphone structure 302b of the second differential silicon-based microphone chip 300b, and the second microphone structure 302a of the first differential silicon-based microphone chip 300a is electrically connected with the first microphone structure 301b of the second differential silicon-based microphone chip 300b. Therefore, the first sound wave electrical signal generated by the first differential silicon-based microphone chip 300a may be superimposed with the second sound wave electrical signal generated by the second differential silicon-based microphone chip 300b, thus, homologous sound wave signals (usually being noise signals) having the same amplitude and the opposite sign in variation in the first sound wave electrical signal and the second sound wave electrical signal may be mutually attenuated or cancelled, thereby improving quality of the audio signal.

In an embodiment, the differential silicon-based microphone chips 300 are fixedly connected with the circuit board 100 with silica gel.

A relatively closed sound cavity 210 is enclosed between the shielding housing 200 and the circuit board 100. In order to shield the devices such as differential silicon-based microphone chips 300 inside the acoustic cavity 210 from suffering the electromagnetic interference, the shielding housing 200 may include a metal housing, and the metal housing is electrically connected with the circuit board 100.

In an embodiment, the shielding housing 200 may be fixedly connected with one side of the circuit board 100 with solder paste or conductive glue.

In an embodiment, the circuit board 100 may include a PCB (printed circuit board).

In some possible embodiments, the silicon-based microphone device may further include at least two sound inlet channel structures.

The sound inlet channel structures are connected to a side of the mounting plate 500 away from the circuit board 100.

One of the at least two sound inlet channel structures is communicated with at least one opening at one end thereof, and is used for obtaining the sound wave in the first region at the other end thereof.

The other one of the at least two sound inlet channel structures is communicated with at least one another opening at one end thereof, and is used for obtaining the sound wave in the second region at the other end thereof.

In the embodiment, the at least two sound inlet channel structures may respectively guide the sound waves in different regions to each of the differential silicon-based microphone chips 300, so that each of the differential silicon-based microphone chips 300 generates a corresponding sound wave electrical signal.

Specifically, as shown in FIG. 1, a first sound inlet sound structure 710 is communicated with the first opening 510 of the mounting plate 500 at one end thereof, and communicated with the back cavity 303a of the first differential silicon-based microphone chip 300a through the first sound inlet hole 110a of the circuit board at the one end thereof. The other end of the first sound inlet channel structure 710 may extend to the first region, so that the sound wave in the first region may be guided by the first sound inlet channel structure 710 to the first differential silicon-based microphone chip 300a, so that the first differential silicon-based microphone chip 300a generates the first sound wave electrical signal.

A second sound inlet channel structure 720 is communicated with the second opening 520 of the mounting plate 500 at one end thereof, and communicated with the back cavity 303b of the second differential silicon-based microphone chip 300b through the second sound inlet hole 110b of the circuit board at the one end thereof. The other end of the second sound inlet channel structure 720 may extend to the second region, so that the sound wave in the second region may be guided by the second sound inlet channel structure 720 to the second differential silicon-based microphone chip 300b, so that the second differential silicon-based microphone chip 300b generates the second sound wave electrical signal.

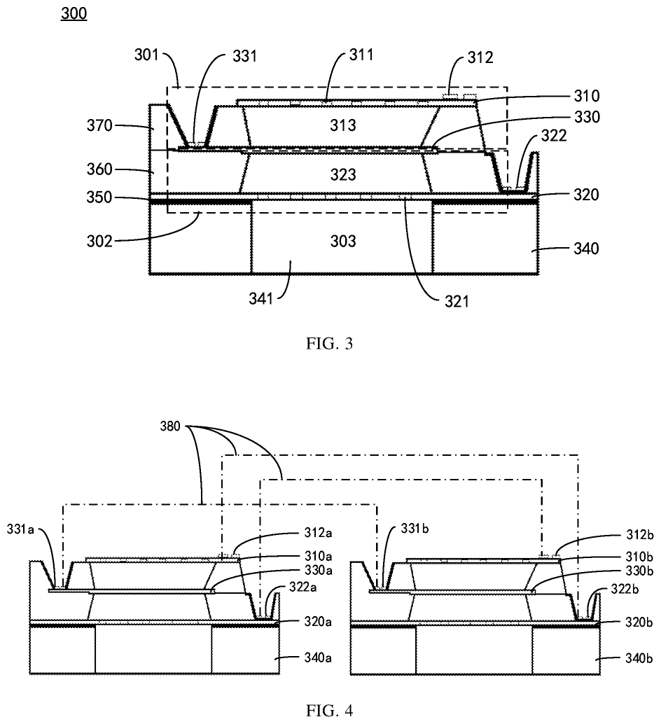

In some possible embodiments, as shown in FIG. 3, the differential silicon-based microphone chip 300 further includes an upper back plate 310, a semiconductor diaphragm 330 and a lower back plate 320 disposed to be stacked and spaced apart from each other. Specifically, gaps, for example, air gaps, are formed between the upper back plate 310 and the semiconductor diaphragm 330 and between the semiconductor diaphragm 330 and the lower back plate 320.

The upper back plate 310 and the semiconductor diaphragm 330 constitute a main body of the first microphone structure 301. The semiconductor diaphragm 330 and the lower back plate 320 constitute a main body of the second microphone structure 302.

Portions of the upper back plate 310 and the lower back plate 320 respectively corresponding to a sound inlet hole are provided with several air flow holes.

For convenience of description, herein, a back plate of the differential silicon-based microphone chip 300 on a side thereof away from the circuit board 100 is defined as the upper back plate 310, and a back plate of the differential silicon-based microphone chip 300 on a side thereof close to the circuit board 100 is defined as the upper back plate 320.

In the embodiment, the semiconductor diaphragm 330 is shared by the first microphone structure 301 and the second microphone structure 302. The semiconductor diaphragm 330 may be implemented with a thinner structure with stronger toughness, and may be deformed and bent under the action of the sound wave. Both the upper back plate 310 and the lower back plate 320 may be implemented with a structure having a thickness much larger than that of the semiconductor diaphragm 330 and a stronger rigidity, which is not easily deformed.

Specifically, the semiconductor diaphragm 330 and the upper back plate 310 may be arranged in parallel and separated by an upper air gap 313, thereby forming the main body of the first microphone structure 301. The semiconductor diaphragm 330 and the lower back plate 320 may be arranged in parallel and separated by a lower air gap 323, thereby forming the main body of the second microphone structure 302. It could be understood that an electric field (non-conduction) may be formed between the semiconductor diaphragm 330 and the upper back plate 310 and between the semiconductor diaphragm 330 and the lower back plate 320. The sound wave entering through the sound inlet hole may contact the semiconductor diaphragm 330 after passing through the back cavity 303 and the lower air flow holes 321 on the lower back plate 320.

When the sound wave enters the back cavity 303 of the differential silicon-based microphone chip 300, the semiconductor diaphragm 330 may be deformed under the action of the sound wave. The deformation may cause the gaps between the semiconductor diaphragm 330 and the upper back plate 310 or the lower back plate 320 to be changed, which may bring about variation in capacitance between the semiconductor diaphragm 330 and the upper back plate 310, and variation in capacitance between the semiconductor diaphragm 330 and the lower back plate 320, that is, the conversion of the sound wave into the electrical signal is realized.

For a single differential silicon-based microphone chip 300, by applying a bias voltage between the semiconductor diaphragm 330 and the upper back plate 310, an upper electric field may be formed in the gap between the semiconductor diaphragm 330 and the upper back plate 310. Similarly, by applying a bias voltage between the semiconductor diaphragm 330 and the lower back plate 320, a lower electric field may be formed in the gap between the semiconductor diaphragm 330 and the lower back plate 320. Since polarity of the upper electric field is opposite to that of the lower electric field, when the semiconductor diaphragm 330 is bent up and down under the action of the sound wave, variation in capacitance of the first microphone structure 301 has the same amplitude as and the opposite sign to variation in capacitance of the second microphone structure 302.

In an embodiment, the semiconductor diaphragm 330 may be made of polysilicon materials, and the semiconductor diaphragm 330 has a thickness of not greater than 1 micrometer, thus the semiconductor diaphragm 330 may be deformed even under an action of a relatively weak sound wave, and the sensitivity is relatively high. Both the upper back plate 310 and the lower back plate 320 may be made of a material with relatively strong rigidity and having a thickness of several micrometers. A plurality of upper airflow holes 311 are formed in the upper back plate 310 by etching, and a plurality of lower airflow holes 321 are formed in the upper back plate 320 by etching. Therefore, when the semiconductor diaphragm 330 is deformed by the action of the sound wave, neither the upper back plate 310 nor the lower back plate 320 may be affected to generate deformation.

In an embodiment, the gap between the semiconductor diaphragm 330 and the upper back plate 310 or the lower back plate 320 is several micrometers, that is, in the order of micrometers.

In some possible embodiments, as shown in FIG. 4, every two of the differential silicon-based microphone chips 300 include a first differential silicon-based microphone chip 300a and a second differential silicon-based microphone chip 300b.

A first upper back plate 310a of the first differential silicon-based microphone chip 300a is electrically connected with a second lower back plate 320b of the second differential silicon-based microphone chip 300b to form a first signal path.

A first lower back plate 320a of the first differential silicon-based microphone chip 300a is electrically connected with a second upper back plate 310b of the second differential silicon-based microphone chip 300b to form a second signal path.

As described in detail above, in a single differential silicon-based microphone chip 300, variation in capacitance of the first microphone structure 301 and variation in capacitance of the second microphone structure 302 have the same amplitude and the opposite sign. Similarly, in every two of the differential silicon-based microphone chips 300, variation in capacitance at the upper back plate 310 of one differential silicon-based microphone chip 300 and variation in capacitance at the lower back plate 320 of the other differential silicon-based microphone chip 300 have the same amplitude and the opposite sign.

Therefore, in the embodiment, a first signal from the first signal path obtained by superimposing a first upper sound wave electrical signal generated at the first upper back plate 310a of the first differential silicon-based microphone chip 300a and a second lower sound wave signal generated at the second lower back plate 320b of the second differential silicon-based microphone chip 300b may attenuate or cancel the homologous noise signal in the first upper sound wave electrical signal and the second lower sound wave electrical signal, thereby improving the quality of the first signal.

Similarly, when a second signal from the second signal path is obtained by superimposing a first lower sound wave electrical signal generated at the first lower back plate 320a of the first differential silicon-based microphone chip 300a and a second upper sound wave electrical signal generated at the second upper back plate 310b of the second differential silicon-based microphone chip 300b may attenuate or cancel the homologous noise signal in the first lower sound wave electrical signal and the second lower sound wave electrical signal, thereby improving the quality of the second signal.

Specifically, a upper back plate electrode 312a of the first upper back plate 310a may be electrically connected with a lower back plate electrode 322b of the second lower back plate 320b through a wire 380 to form the first signal path. A lower back plate electrodes 322a of the first lower back plate 320a may be electrically connected with a upper back plate electrodes 312b of the second upper back plate 310b through a wire 380 to form the second signal path.

In some possible embodiments, as shown in FIG. 4, the first semiconductor diaphragm 330a of the first differential silicon-based microphone chip 300a is electrically connected with the second semiconductor diaphragm 330b of the second differential silicon-based microphone chip 300b, and at least one of the first semiconductor diaphragm 330a and the second semiconductor diaphragm 330b is electrically connected with a constant voltage source.

In the embodiment, the first semiconductor diaphragm 330a of the first differential silicon-based microphone chip 300a is electrically connected with the second semiconductor diaphragm 330b of the second differential silicon-based microphone chip 300b, so that the semiconductor diaphragms 330 of the two differential silicon-based microphone chips 300 may have the same potential. That is, the criterion that the two differential silicon-based microphone chips 300 generate electrical signals may be unified.

Specifically, a wire 380 may be respectively electrically connected with the semiconductor diaphragm electrode 331a of the first semiconductor diaphragm 330a and the semiconductor diaphragm electrode 331b of the second semiconductor diaphragm 330b.

In an embodiment, the semiconductor diaphragms 330 of all of the differential silicon-based microphone chips 300 may be electrically connected, so that the criterion that the differential silicon-based microphone chips 300 generate electrical signals may be unified.

In some possible embodiments, as shown in FIG. 1, the silicon-based microphone device further includes a control chip 400.

The control chip 400 is located inside the sound cavity 210 and is electrically connected with the circuit board 100.

One of the first upper back plate 310a and the second lower back plate 320b is electrically connected with one signal input end of the control chip 400. One of the first lower back plate 320a and the second upper back plate 310b is electrically connected with another signal input end of the control chip 400.

In the embodiment, the control chip 400 is used to receive two path signals output by the aforementioned differential silicon-based microphone chips 300 in which a physical noise removal has been completed, preform a secondary noise removal or the like on the two path signals, and then output them to the next-level device or component.

In an embodiment, the control chip 400 is fixedly connected with the circuit board 100 with silica gel or red glue.

In an embodiment, the control chip 400 includes an application specific integrated circuit (ASIC) chip. The ASIC chip may be implemented with a differential amplifier with two inputs. For different application scenarios, the output signal of the ASIC chip may be a single-end signal, or may be a differential output signal.

In some possible embodiments, as shown in FIG. 3, the differential silicon-based microphone chip 300 includes a silicon substrate 340.

The first microphone structure 301 and the second microphone structure 302 are disposed to be stacked on one side of the silicon substrate 340.

The silicon substrate 340 has a via hole 341 for forming the back cavity 303, and the via hole 341 corresponds to both the first microphone structure 301 and the second microphone structure 302. The silicon substrate 340 is fixedly connected with the circuit board 100 at a side thereof far away from the first microphone structure 301 and the second microphone structure 302. The via hole 341 is communicated with the sound inlet hole.

In the embodiment, the silicon substrate 340 supports the first microphone structure 301 and the second microphone structure 302. The via hole 341 in the silicon substrate 340 and for forming the back cavity 303 may facilitate the entry of the sound waves into the differential silicon-based microphone chip 300. The sound waves may act on the first microphone structure 301 and the second microphone structure 302 respectively, so that the first microphone structure 301 and the second microphone structure 302 generate differential electrical signals.

In some possible embodiments, as shown in FIG. 3, the differential silicon-based microphone chip 300 further includes a patterned first insulating layer 350, a patterned second insulating layer 360 and a patterned third insulating layer 370.

The substrate, the first insulating layer 350, the lower back plate 320, the second insulating layer 360, the semiconductor diaphragm 330, the third insulating layer 370 and the upper back plate 310 are disposed to be stacked sequentially.

In the embodiment, the lower back plate 320 and the silicon substrate 340 are separated from each other by the patterned first insulating layer 350, and the semiconductor diaphragm 330 and the lower back plate 320 are separated from each other by the patterned second insulating layer 360, and the upper back plate 310 and the semiconductor diaphragm 330 are separated from each other by the patterned third insulating layer 370, so that an electrical isolation is formed between the conductive layers, and a short circuit between the conductive layers which may reduce the signal accuracy may be avoided.

In an embodiment, each of the first insulating layer 350, the second insulating layer 360 and the third insulating layer 370 may be formed by forming an integrated film and then patterning the integrated film by an etching process to remove a portion of the integrated film corresponding to an area of the via hole 341 and an area for preparing an electrode.

In some possible embodiments, the silicon-based microphone device further includes a connecting ring.

The connecting ring is connected between one of the openings of the mounting plate 500 and a respective one of the sound inlet holes of the circuit board 100, so that an air-tight sound channel is formed between the opening and the sound inlet hole.

In the embodiment, the connecting ring may form a sound inlet channel having gas tightness between the opening of the mounting plate 500 and the sound inlet hole of the circuit board 100, which may guide the sound wave in the first region or the second region to be applied on the differential silicon-based microphone chip 300.

Specifically, as shown in FIG. 2, a first connecting ring 610 forms a sound inlet channel having gas tightness between the first opening 510 of the mounting plate 500 and the first sound inlet hole 110a of the circuit board 100. A second connecting ring 620 forms a sound inlet channel having gas tightness between the second opening 520 of the mounting plate 500 and the second sound inlet hole 110b of the circuit board 100.

It is to be noted that the silicon-based microphone device in the above-mentioned embodiments of the present disclosure is illustrated by using a differential silicon-based microphone chips 300 implemented with a single diaphragm (for example, the semiconductor diaphragm 330), and two back electrodes (for example, the upper back plate 310 and the lower back plate 320) as an example. However, in addition to an arrangement of the single diaphragm and two back electrodes, the differential silicon-based microphone chip 300 may also be implemented by two diaphragms and a single back electrode, or other differential structures.

Based on the same inventive concept, an embodiment of the present disclosure provides an electronic apparatus, including the silicon-based microphone device described in any one of the described embodiments as above.

In the embodiment, the electronic apparatus may be a smart home product with large internal noise such as a mobile phone, a TWS (True Wireless Stereo) headset, a robot vacuum cleaner, a smart air conditioner, and a smart kitchen ventilator. Since each of the electronic apparatus adopts the silicon-based microphone device described in the foregoing embodiments, the principles and technical effects thereof may refer to the foregoing embodiments, and will not be repeated herein.

In some possible embodiments, the exterior of the electronic apparatus is the first region, and the interior of the electronic apparatus is the second region.

In the at least two sound inlet channel structures of the silicon-based microphone device, one end of one of the sound inlet channel structure protrudes from the electronic apparatus to obtain the sound wave outside the electronic apparatus. One end of the other one of the sound inlet channel structure is located inside the electronic apparatus to obtain the sound wave inside the electronic apparatus.

In the embodiment, specifically, as shown in FIG. 1, one end of the first sound inlet channel structure 710 may be extended to the outside of the electronic apparatus, so that the sound wave outside the electronic apparatus may be guided by the first sound inlet channel structure 710 to the first differential silicon-based microphone chip 300a, causing the first differential silicon-based microphone chip 300a to generate the first sound wave electrical signal. The sound wave outside the electronic apparatus may include a target sound wave, and a noise generated by the electronic apparatus during operation and spreading to the outside of the device. Alternatively, the target sound wave may be a voice command.

One end of the second sound inlet channel structure 720 may be left inside the electronic apparatus, so that the sound wave inside the electronic apparatus may be guided by the second sound inlet channel structure 720 to the second differential silicon-based microphone chip 300b, causing the second differential silicon-based microphone chip 300b to generate the second sound wave electrical signal. The sound wave inside the electronic apparatus may include the noise generated by the electronic apparatus during operation.

In some possible embodiments, the mounting plate 500 in the silicon-based microphone device is the mainboard of the electronic apparatus. As such, the structure of the electronic device itself can be fully utilized, manufacturing costs can be reduced, and it is also beneficial for controlling the volume of the device.

Optionally, the connecting ring 600 may be implemented with conductive materials, and may realize an electrical connection between the circuit board 100 and the mainboard. Thus an electrical signal interaction between the circuit board 100 and the mainboard may be realized.

By applying the embodiments of the present disclosure, at least the following beneficial effects can be achieved.

1) An even number of differential silicon-based microphone chips 300 are used for acoustic-electrical conversion, and in every two of the differential silicon-based microphone chips 300, the back cavity 303 of one of the differential silicon-based microphone chips 300 obtains the sound wave in the first region through the sound inlet hole in the circuit board 100 and the opening in the mounting plate 500. Thus, the sound wave in the first region may be applied to the differential silicon-based microphone chip 300, and the differential silicon-based microphone chip 300 generates a first sound wave electrical signal.

2) The back cavity 303 of the other one of the differential silicon-based microphone chips 300 obtains the sound wave in the second region through the sound inlet hole on the circuit board 100 and the opening on the mounting plate 500. Thus, the sound wave in the second region may be applied to the differential silicon-based microphone chip 300, and the differential silicon-based microphone chip 300 generates a second sound wave electrical signal.

3) In every two of the differential silicon-based microphone chips 300, the first microphone structure 301 of one of the differential silicon-based microphone chips 300 is electrically connected with the second microphone structure 302 of the other one of the differential silicon-based microphone chips 300, and the second microphone structure 302 of the one of the differential silicon-based microphone chips 300 is electrically connected with the first microphone structure 301 of the other one of the differential silicon-based microphone chips 300. Thus, the first sound wave electrical signal generated by the one of the differential silicon-based microphone chips 300 may be superimposed with the first sound wave electrical signal generated by the other one of the differential silicon-based microphone chips 300, such that the homologous sound wave signals (usually being noise signals) having the same amplitude and the opposite sign in variation in the first sound wave electrical signal and the second sound wave electrical signal may be attenuated or cancelled, thereby improving the quality of the audio signal.

4) The at least two sound inlet channel structures may respectively guide the sound waves in different regions to each of the differential silicon-based microphone chips 300. Thus, each of the differential silicon-based microphone chips 300 generates a corresponding sound wave electrical signal.

5) The relatively closed sound cavity 210 is enclosed between the shielding housing 200 and the circuit board 100, the shielding housing 200 includes a metal housing, and the metal housing is electrically connected with the circuit board 100. Thus, the effect of shielding electromagnetic interference for devices such as the differential silicon-based microphone chips 300 inside the acoustic cavity 210 may be achieved.

6) The semiconductor diaphragm 330 is shared by the first microphone structure 301 and the second microphone structure 302. When the sound wave enters into the back cavity 303 of the differential silicon-based microphone chip 300, the semiconductor diaphragm 330 may be deformed under the action of the sound wave. The deformation may cause the gap between the semiconductor diaphragm 330 and the upper back plate 310 or the lower back plate 320 to be changed, and thus may bring about variation in capacitance between the semiconductor diaphragm 330 and the upper back plate 310, and variation in capacitance between the semiconductor diaphragm 330 and the lower back plate 320. That is, the conversion of sound waves into electrical signals may be realized.

7) By applying a bias voltage between the semiconductor diaphragm 330 and the upper back plate 310, an upper electric field may be formed in the gap between the semiconductor diaphragm 330 and the upper back plate 310. Similarly, by applying a bias voltage between the semiconductor diaphragm 330 and the lower back plate 320, a lower electric field may be formed in the gap between the semiconductor diaphragm 330 and the lower back plate 320. Since the polarity of the upper electric field is opposite to that of the lower electric field, when the semiconductor diaphragm 330 is bent up and down under the action of the sound waves, the variation in capacitance of the first microphone structure 301 has the same amplitude as and the opposite sign to the variation in capacitance of the second microphone structure 302.

8) The control chip 400 is used to receive two path signals output by the aforementioned differential silicon-based microphone chips 300 in which a physical noise removal has been completed, preform a secondary noise removal or the like on the two path signals, and then output them to the next-level device or component.

9) The lower back plate 320 and the silicon substrate 340 are separated from each other by the first insulating layer 350, the semiconductor diaphragm 330 and the upper back plate 310 are separated from each other by the second insulating layer 360, and the upper back plate 310 and the semiconductor diaphragm 330 are separated from each other by the third insulating layer 370. Thus, an electrical isolation between the conductive layers may be formed, and a short circuit between the conductive layers, which may reduce the signal accuracy, may be avoided.

10) The connecting rings may form sound inlet channels having gas tightness between the openings of the mounting plate 500 and the sound inlet holes of the circuit board 100. Thus, the sound wave in the first region or the second region may be guided to be applied on the differential silicon-based microphone chip 300.

It is to be understood by those skilled in the art that various steps, measures and solutions in the operations, methods, and processes that have been discussed in the present disclosure may be alternated, modified, combined or deleted. Further, other steps, measures and solutions in the operations, methods, and processes that have been discussed in the present disclosure may be alternated, modified, rearranged, split, combined or deleted. Further, steps, measures and solutions in the operations, methods, and processes in the prior art may be alternated, modified, rearranged, split, combined or deleted.

In the description of the present disclosure, it is to be understood that orientations or positional relationships indicated by the terms “center”, “upper”, “lower”, “front”, “rear”, “left”, “right”, “vertical”, “horizontal”, “top”, “bottom”, “inside”, “outside” and so on are based on the orientations or positional relationships shown in the accompanying drawings, which are only for convenience of describing the present disclosure and simplifying the description, rather than indicating or implying that the device or element referred necessarily has a particular orientation, needs to be constructed and operated in a particular orientation, and therefore, those terms should not be construed as a limitation to the present disclosure.

The terms “first” and “second” are used for describing purposes only, and should not be understood as indicating or implying relative importance or implying the number of technical features indicated. Thus, a feature defined by “first” or “second” may expressly or implicitly include one or more of such features. In the description of the present disclosure, unless stated otherwise, “plurality of” means two or more than two.

In the description of the present disclosure, it is to be noted that, unless otherwise expressly specified and limited, the terms “installation”, “connected” and “connection” should be understood in a broader sense. For example, a connection may be a fixed connection or a removable connection, or an integral connection; a connection may be directly connection, or indirectly connection through an intermediate medium, or may be an internal communication of two elements. The specific meanings of the above terms in the present disclosure may be understood by those ordinary skilled in the art according to specific situations.

In the description of the present specification, the particular features, structures, materials or characteristics may be combined in any suitable manner in any one or more of the embodiments or examples.

The above description is only some embodiments of the present disclosure, it is to be noted that, some improvements and modifications may also be made by those ordinary skilled in the art without departing from the principle of the present disclosure. These improvements and modifications should also be considered to be within the scope of the present disclosure.

1. A silicon-based microphone device, comprising:
a circuit board provided with at least two sound inlet holes;
a shielding housing covering one side of the circuit board and forming a sound cavity with the circuit board;
an even number of differential silicon-based microphone chips, located inside the sound cavity, wherein the differential silicon-based microphone chips are respectively disposed at the sound inlet holes, and a back cavity of each of the differential silicon-based microphone chips is communicated with a corresponding one of the sound inlet holes; and in every two of the differential silicon-based microphone chips, a first microphone structure of one of the differential silicon-based microphone chips is electrically connected with a second microphone structure of the other one of the differential silicon-based microphone chips, and a second microphone structure of the one of the differential silicon-based microphone chips is electrically connected with a first microphone structure of the other one of the differential silicon-based microphone chips; and
a mounting plate disposed on a side of the circuit board away from the shielding housing, wherein the mounting plate is provided therein with an even number of openings, the openings are communicated with the sound inlet holes, respectively; at least one of the openings is used for obtaining a sound wave in a first region, and at least another one of the openings is used for obtaining a sound wave in a second region.

2. The silicon-based microphone device of claim 1, wherein in every two of the openings, one of the openings is used for obtaining the sound wave in the first region, and the other one of the openings is used for obtaining the sound wave in the second region.

3. The silicon-based microphone device of claim 1, further comprising at least two sound inlet channel structures,
the sound inlet channel structures are connected to a side of the mounting plate away from the circuit board,
one of the at least two sound channel structures is communicated with the at least one of the openings at one end thereof, and obtains the sound wave in the first region at the other end thereof; and
another one of the at least two sound inlet channel structures is communicated with at least another one of the openings at one end thereof, and obtains the sound wave in the second region at the other end thereof.

4. The silicon-based microphone device of claim 1, wherein each of the differential silicon-based microphone chips further an upper back plate, a semiconductor diaphragm and a lower back plate disposed to be stacked and spaced apart from each other,
the upper back plate and the semiconductor diaphragm constitute a main body of the first microphone structure; and the semiconductor diaphragm and the lower back plate constitute a main body of the second microphone structure; and
portions of the upper back plate and the lower back plate corresponding to one of the sound inlet holes are provided with a plurality of air flow holes.

5. The silicon-based microphone device of claim 4, wherein every two of the differential silicon-based microphone chips include a first differential silicon-based microphone chip and a second differential silicon-based microphone chip,
a first upper back plate of the first differential silicon-based microphone chip is electrically connected with a second lower back plate of the second differential silicon-based microphone chip to form a first signal path, and
a first lower back plate of the first differential silicon-based microphone chip is electrically connected with a second upper back plate of the second differential silicon-based microphone chip to form a second signal path.

6. The silicon-based microphone device of claim 5, wherein a first semiconductor diaphragm of the first differential silicon-based microphone chip is electrically connected with a second semiconductor diaphragm of the second differential silicon-based microphone chip, and at least one of the first semiconductor diaphragm and the second semiconductor diaphragm is electrically connected with a constant voltage source.

7. The silicon-based microphone device of claim 6, further comprising a control chip located inside the sound cavity and electrically connected with the circuit board, and
one of the first upper back plate and the second lower back plate is electrically connected with one signal input end of the control chip, and one of the first lower back plate and the second upper back plate is electrically connected with another signal input end of the control chip.

8. The silicon-based microphone device of claim 4, wherein each of the differential silicon-based microphone chips comprises a silicon substrate,
the first microphone structure and the second microphone structure are disposed to be stacked on one side of the silicon substrate, and
the silicon substrate has a via hole for forming the back cavity, and the via hole corresponds to both of the first microphone structure and the second microphone structure, the silicon substrate is fixedly connected with the circuit board at a side thereof far away from the first microphone structure and the second microphone structure, and the via hole is communicated with one of the sound inlet holes.

9. The silicon-based microphone device of claim 8, wherein each of the differential silicon-based microphone chips further comprises a patterned first insulating layer, a patterned second insulating layer and a patterned third insulating layer, and
the substrate, the first insulating layer, the lower back plate, the second insulating layer, the semiconductor diaphragm, the third insulating layer and the upper back plate are disposed to be stacked sequentially.

10. The silicon-based microphone device of claim 1, further comprising a connecting ring connected between one of the openings of the mounting plate and a respective one of the sound inlet holes of the circuit board, so that an air-tight sound channel is formed between the one of the openings and the respective one of the sound inlet holes.

11. The silicon-based microphone device of claim 1, wherein the silicon-based microphone device has at least one of the following arrangements:
the differential silicon-based microphone chips are fixedly connected with the circuit board with silica gel;
the shielding housing includes a metal housing, and the metal housing is electrically connected with the circuit board;
the shielding housing is fixedly connected with one side of the circuit board with solder paste or conductive glue; and
the circuit board includes a printed circuit board.

12. An electronic apparatus comprising a silicon-based microphone device of claim 1.

13. The electronic apparatus of claim 12, wherein an outside of the electronic apparatus is a first region, and an inside of the electronic apparatus is a second region; and
in at least two sound inlet channel structures of the silicon-based microphone device, one end of one of the sound inlet channel structures protrudes outwards from the electronic apparatus to obtain a sound wave outside the electronic apparatus, and one end of another one of the sound inlet channel structures is located inside the electronic apparatus to obtain the sound wave inside the electronic apparatus.

14. The electronic apparatus of claim 12, wherein a mounting plate included in the silicon-based microphone device is a mainboard of the electronic apparatus.
